(19) United States
(12) Patent Application Publication
(10) Pub. No.: US 2009/0215351 A1
(43) Pub. Date: Aug. 27, 2009

(54) Manufaturing method of display device

(75) Inventors: Setsuo Kobayashi, Mobara (JP); Hiroaki Miwa, Yokohama (JP); Katsuhiko Ishii, Chosei (JP)

Correspondence Address: Stanley P. Fisher;Reed Smith LLp, Suite 1400, 3110 Fairview Park Drive, Falls Church, VA, 22042-4503, US

(73) Assignee: Hitachi Displays, Ltd.

(21) Appl. No.: 12/320,589

(22) Filed: Jan. 29, 2009

(30) Foreign Application Priority Data
Feb. 21, 2008 (JP) 2008-039722

(51) Int. Cl. H01J 9/20

(52) U.S. Cl. 445/24

(57) ABSTRACT

A method of manufacturing a display device in which a transparent substrate is bonded to a display panel by an adhesive, includes: applying the adhesive to the display panel or the transparent substrate in a predetermined pattern; bonding the display panel and the transparent substrate together by means of the adhesive after the applying step; and curing the adhesive after the bonding step, wherein in the applying step, a viscosity of the adhesive being more than 5000 mPa·s and 15000 mPa·s or less, the application of the adhesive is carried out by a screen printing, a time from a finishing point of the application of the adhesive in the applying step until a starting point of the bonding in the bonding step is 10 seconds or more and 120 seconds or less, in the bonding step, in a condition in which the adhesive applied in the applying step is spreading, with air bubbles remaining, and a maximum size of the air bubbles is 0.5 mm or less, the display panel and the transparent substrate are bonded together by the adhesive under a reduced pressure atmosphere lower than the atmospheric pressure, and in the curing step, after the maximum size of the air bubbles have reached 0.1 mm or less, ultraviolet light is applied, curing the adhesive.

The present application claims priority from Japanese application JP 2008-39722 filed on Feb. 21, 2008, the content of which is hereby incorporated by reference into this application.

### BACKGROUND OF THE INVENTION

1. Technical Field

The present invention relates to a display device manufacturing method, and particularly, to a method of manufacturing a display device in which a transparent substrate (a protective cover) is bonded to a display panel by means of an adhesive.

2. Related Art

Display devices, such as liquid crystal display devices, are employed as display devices of various sizes from a small one for a portable telephone to a large one for a TV set.

FIG. 10 is a sectional view illustrating a heretofore known liquid crystal display device. FIG. 10 shows a condition in which a display panel PNL such as, for example, a liquid crystal display panel is fitted on a casing CAS of a portable telephone or the like. In the case of the liquid crystal display panel, the display panel PNL has, for example, a substrate SUB1, a substrate SUB2, a seal material SL, which bonds the substrate SUB1 and the substrate SUB2 together, a liquid crystal LC sealed in within a portion surrounded by the substrate SUB1, the substrate SUB2, and the seal material SL, a polarizing plate POL1 disposed on a side of the substrate SUB1 opposite the liquid crystal LC, and a polarizing plate POL2 disposed on a side of the substrate SUB2 opposite the liquid crystal LC.

The display panel PNL is disposed in such a way as to overlap an opening provided in the casing CAS. A transparent substrate (a protective cover) COV, made of, for example, glass or acryl (PMMA), is affixed over the opening of the casing CAS by means of a double sided tape TAP or the like. Then, in the case of the liquid crystal display device shown in the figure, a space SP in which an air layer is interposed has existed between the display panel PNL and the transparent substrate COV.

Apart from the liquid crystal display device shown in FIG. 10, for example, as in JP-A-10-254380, there is a liquid crystal display device in which a transparent substrate such as a reinforcing substrate is bonded to a liquid crystal panel by means of an ultraviolet curable or thermosetting adhesive. At this time, in JP-A-10-254380, it is described that, in order to suppress a remaining of air bubbles, by forming a high viscosity adhesive having a viscosity of 10,000 to 100,000 cP (1 cP=1 mPa·s) on a perimeter, applying a low viscosity adhesive having a viscosity of 100 to 1,000 cP to an inner side thereof, and bonding the transparent substrate and the liquid crystal panel together under vacuum (under a reduced pressure), even in the event that small air bubbles having a diameter of around 1 mm are drawn in, by returning them to the atmospheric pressure, it is possible to cause the air bubbles to disappear. Then, 100 to 1,000 cP is described as a viscosity at which the air bubbles are unlikely to be drawn in.

In addition, regarding a technology which suppresses a remaining of air bubbles, there are, for example, JP-A-2006-36865 and JP-A-2005-243413. In JP-A-2006-36865, it is described that, a thermosetting adhesive and air bubbles being disposed in a pattern, the air bubbles are dissolved under a first heating temperature, at which the adhesive is not cured, as well as a reduced pressure (vacuum), and subsequently, as well as a pressure being applied, the adhesive is cured at a second heating temperature. At this time, it is described that the adhesive is formed into dots or cross stripes (a grid), and a viscosity of the adhesive when applied is 1000 cP or more, while a viscosity of the adhesive when heated at the first heating temperature is 100 cP or less.

Also, in JP-A-2005-243413, it is described that, when carrying out a vacuum bonding in such a way that there is no remaining of air bubbles, an ultraviolet curable adhesive resin for temporary fixing is disposed at corners, and a thermosetting adhesive resin for sealing is formed into lines or dots.

Also, prior to the present application, the present applicant has filed an application relating to a method of manufacturing a display device in which a transparent substrate is bonded to a display panel by means of an adhesive (Japanese Patent Application No. 2006-346932)

### SUMMARY OF THE INVENTION

However, in the case of the configuration shown in FIG. 10, as the air layer is interposed in the space SP portion, a visibility may be reduced due to a surface reflection caused by a difference in refractive index between the air layer and the transparent substrate COV or the like.

Also, in the case of the technology described in JP-A-10-254380, as the viscosity of the low viscosity adhesive is low, it is necessary to provide the high viscosity adhesive on the perimeter. Consequently, an application step becomes complicated. Furthermore, unless a height of the low viscosity adhesive is controlled with a high accuracy, a difference occurs in level between the low viscosity adhesive and the high viscosity adhesive, there is a possibility of larger air bubbles occurring.

Also, in the case of the technology described in JP-A-2006-36865, when the viscosity is increased at the first heating temperature at which the thermosetting adhesive is not cured, an upper temperature limit of the display panel may be exceeded.

Also, in the case of the technology described in JP-A-2005-243413, no description being given of a size or viscosity when the thermosetting adhesive resin for sealing is formed in lines or dots, in the event that adjacent sealing adhesive resin lines or dots are spaced wide apart, there is a possibility of drawing in large air bubbles. Also, as the adhesive resin is thermosetting, the upper temperature limit of the display panel may be exceeded.

Also, in the case of the technology described in Patent Application No. 2006-346932, although the viscosity of the adhesive before being cured is made 2000 to 5000 mPa·s, in the case in which the viscosity is 5000 mPa s or less, when a screen printing is carried out, the adhesive being likely to encroach upon an underside of a screen plate, it is necessary to clean the underside of the screen plate after 20 to 30 shots, resulting in an increasing length of time being required for the manufacturing.

In the display device manufacturing method of the invention, when bonding the display panel and the transparent substrate together by means of the adhesive under a reduced pressure atmosphere, by adjusting one or more of an adhesive viscosity and application pattern, a size of air bubbles at the time of the bonding, a curing method, and the like, it is possible to suppress the remaining of the air bubbles, and shorten the time required for the manufacturing.

As the configuration of the invention, it is possible to adopt, for example, the following one.

1. A display device manufacturing method in which a transparent substrate is bonded to a display panel by means of an adhesive, includes:

an application step which applies the adhesive to the display panel or the transparent substrate in a predetermined pattern;

a bonding step which bonds the display panel and the transparent substrate together by means of the adhesive after the application step; and

a curing step which cures the adhesive after the bonding step.

In the application step, a viscosity of the adhesive being more than 5000 mPa·s and 15000 mPa·s or less, the application of the adhesive is carried out by means of a screen printing,

a time from a finishing point of the application of the adhesive in the application step until a starting point of the bonding in the bonding step is 10 seconds or more and 120 seconds or less,

in the bonding step, in a condition in which the adhesive applied in the application step is spreading, with air bubbles remaining, and a maximum size of the air bubbles is 0.5 mm or less, the display panel and the transparent substrate are bonded together by means of the adhesive under a reduced pressure atmosphere lower than the atmospheric pressure, and

in the curing step, after the maximum size of the air bubbles have reached 0.1 mm or less, ultraviolet light is applied, curing the adhesive.

2. According to 1, it is also acceptable to adopt a configuration such that the time from the adhesive application finishing point in the application step until the bonding starting point in the bonding step is 30 seconds or more and 60 seconds or less.

3. According to 1 or 2, it is also acceptable to adopt a configuration such that the predetermined pattern of the adhesive is a pattern of a plurality of dots.

4. According to 3, it is also acceptable to adopt a configuration such that the pattern of the plurality of dots is a pattern of staggered dots.

5. According to 1 or 2, it is also acceptable to adopt a configuration such that the predetermined pattern of the adhesive is a grid pattern.

6. According to any one of 1 to 5, it is also acceptable to adopt a configuration such that, in the bonding step, a vacuum is 1 to 50 Torr.

7. According to any one of 1 to 6, it is also acceptable to adopt a configuration such that, in the bonding step, the display panel and the transparent substrate are bonded together by means of the adhesive while the display panel is being bent in such a way as to be convex on a surface to be bonded.

8. According to 7, it is also acceptable to adopt a configuration such that the display panel has a first substrate, and a second substrate disposed facing the first substrate, and

a sum of a thickness of the first substrate and a thickness of the second substrate is 0.6 mm or less.

9. According to any one of 1 to 8, it is also acceptable to adopt a configuration such that, in the curing step, the adhesive is cured using both heat and the ultraviolet light.

10. According to 9, it is also acceptable to adopt a configuration such that a light shield is included in one portion of the transparent substrate.

11. According to 9 or 10, it is also acceptable to adopt a configuration such that the heat is of 50 to 80° C.

12. According to any one of 1 to 11, it is also acceptable to adopt a configuration such that the transparent substrate contains one or more of glass, an acrylic resin, and a polycarbonate resin.

13. According to any one of 1 to 12, it is also acceptable to adopt a configuration such that the adhesive contains an acrylic resin or an epoxy resin.

14. According to any one of 1 to 13, it is also acceptable to adopt a configuration such that, in the bonding step and the curing step, in a condition in which the display panel and the transparent substrate are bonded together, each of the display panel and the transparent substrate is fixed into position with a jig.

15. According to any one of 1 to 14, it is also acceptable to adopt a configuration such that an elastic modulus of the adhesive after being cured is 1,000 to 250,000 Pa at 25° C.

16. According to any one of 1 to 15, it is also acceptable to adopt a configuration such that the display panel is a liquid crystal display panel.

The heretofore described configuration being only one example, the invention can be appropriately modified without departing from the scope of the technological idea. Also, a configuration example of the invention other than the heretofore described configuration will be made apparent from the description of the whole of the specification of the invention, and the drawings.

Typical advantages achieved by the invention are as follows.

It is possible to suppress the remaining of the air bubbles when bonding the transparent substrate to the display panel by means of the adhesive.

It is possible to shorten the time required for the manufacturing when bonding the transparent substrate to the display panel by means of the adhesive.

Other advantages of the invention will be made apparent from the description of the whole of the specification.

### BRIEF DESCRIPTION OF THE DRAWINGS

FIG. 1 is a sectional view illustrating one example of a display device of an embodiment 1 of the invention;

FIGS. 2A to 2C are perspective views illustrating one example of a method of manufacturing the display device of the embodiment 1 of the invention;

FIGS. 3A and 3B are plan views illustrating one example of a pattern in which an adhesive is applied;

FIGS. 4A and 4B are plan views illustrating another example of a pattern in which the adhesive is applied;

FIGS. 5A and 5B are plan views illustrating still another example of a pattern in which the adhesive is applied;

FIG. 6 is a side view illustrating one example of a method of manufacturing a display device of an embodiment 2 of the invention;

FIG. 7 is a sectional view illustrating one example of a display device of an embodiment 3 of the invention;

FIG. 8 is a sectional view illustrating one example of a display device of an embodiment 4 of the invention;

FIG. 9 is a sectional view illustrating one example of a display device of an embodiment 5 of the invention; and

FIG. 10 is a sectional view illustrating a heretofore known liquid crystal display device.

### DESCRIPTION OF THE PREFERRED EMBODIMENTS

A description will be given of embodiments of the invention, referring to the drawings. In each drawing and each embodiment, identical or similar components being identified by the same reference numbers and characters, a description will be omitted.

### Embodiment 1

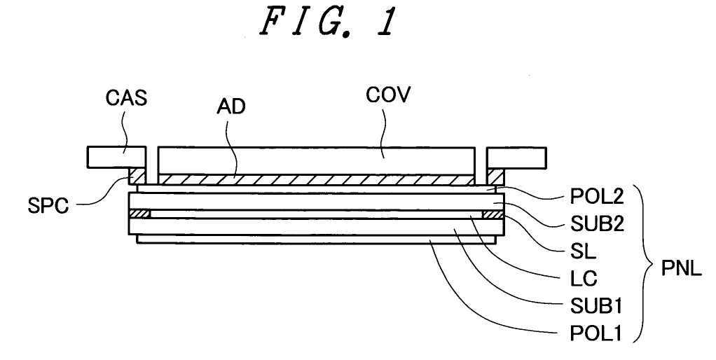

FIG. 1 is a sectional view illustrating one example of a display device of an embodiment 1 of the invention. In the embodiment 1, a description will be given exemplifying a case of using a liquid crystal display device as a display panel PNL. FIG. 1 also shows a condition in which a display panel PNL such as, for example, a liquid crystal display device is fitted on a casing CAS of a portable telephone or the like.

The display panel PNL has a substrate SUB1, which is a transmissive insulating substrate made of, for example, glass, a substrate SUB2, which is a transmissive insulating substrate made of, for example, glass, a seal material SL, which bonds the substrate SUB1 and the substrate SUB2 together, a liquid crystal LC sealed in within a portion surrounded by the substrate SUB1, the substrate SUB2, and the seal material SL, a polarizing plate POL1 disposed on a side of the substrate SUB1 opposite the liquid crystal LC, and a polarizing plate POL2 disposed on a side of the substrate SUB2 opposite the liquid crystal LC. Also, although not shown in the figure, thin film transistors, pixel electrodes, and the like, being formed in a matrix form on a liquid crystal LC side of the substrate SUB1, the substrate SUB1 may be called a TFT substrate. Although not shown in the figure, a color filter, opposing electrodes, and the like, being formed on a liquid crystal LC side of the substrate SUB2, the substrate SUB2 may be called an opposing substrate. Also, it is also acceptable to dispose a retardation film or the like in at least one of a space between the substrate SUB1 and the polarizing plate POLL or a space between the substrate SUB2 and the polarizing plate POL2. As the invention is not particularly limited to a configuration of the display panel PNL, it is also acceptable to adopt a configuration other than the configuration described here.

Then, a transparent substrate (a protective cover) COV containing one or more of, for example, glass, an acrylic resin, a polycarbonate resin, and the like, is bonded to the display panel PNL by means of an adhesive AD. FIG. 1 shows an example in which the transparent substrate COV is bonded to the polarizing plate POL2, but this is not limiting. Then, the display panel PNL to which is bonded the transparent substrate COV is disposed in such a way as to overlap an opening provided in the casing CAS. FIG. 1 shows an example in which the transparent substrate COV is inserted inside the opening of the casing CAS.

Herein, in the event that materials having approximately equal refractive indices are used as materials of the transparent substrate COV, adhesive AD, polarizing plate POL2 and the like, as it is possible to suppress a surface reflection, it is possible to suppress a reduction in visibility. In particular, as glass and an acrylic resin have approximately equal refractive indices, it is desirable to employ these materials. However, this combination not being limiting, it is also acceptable to use materials, a refractive index difference between two of which is 0.1 or less. Needless to say, as long as the surface reflection is within an allowable range, a use of materials having a refractive index of 0.1 or more shall not be precluded.

A spacer SPC is disposed between the display panel PNL and the casing CAS. Provided that the spacer SPC is provided with a viscosity or an adhesiveness, a fixing becomes possible. Also, it is also acceptable to use a material having an elasticity for the spacer SPC. Furthermore, provided that the spacer SPC is formed in a frame shape from a waterproof material such as, for example, silicon rubber, it is possible to prevent water or the like from entering through the opening of the casing CAS.

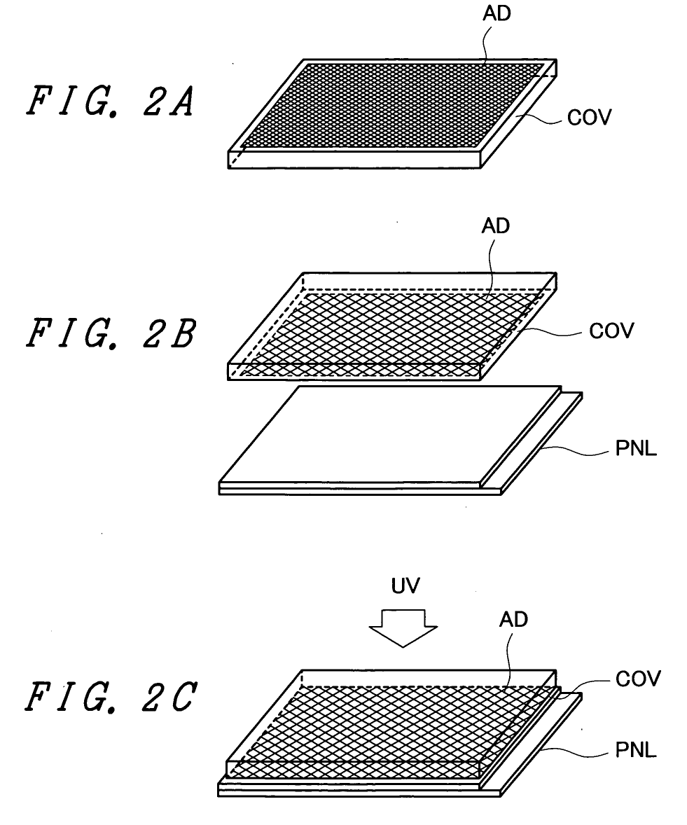

FIGS. 2A to 2C are perspective views illustrating one example of a method of manufacturing the display device of the embodiment 1 of the invention.

Firstly, as shown in FIG. 2A, the adhesive AD is applied to the transparent substrate COV. In the embodiment, as the adhesive AD, one is used of which a viscosity is more than 5000 mPa·s and 15000 mPa·s or less in a condition in which it has not yet been cured. In the invention, a screen printing is used as a method of applying the adhesive AD. At this time, as will be described hereafter, it is desirable to apply the adhesive AD in a predetermined pattern. Also, it is desirable that the adhesive AD is applied to all but a perimeter of the transparent substrate COV, because it is possible to prevent the adhesive AD from overflowing out of the transparent substrate COV. Then, when left in this condition for a while, the adhesive AD spreads, and a size of air bubbles decreases.

Next, as shown in FIG. 2B, the transparent substrate COV is turned over when necessary. Then, under a reduced pressure atmosphere lower than the atmospheric pressure, for example, at a vacuum of 1 to 50 Torr, desirably, 5 to 10 Torr, the display panel PNL and the transparent substrate COV are bonded together by means of the adhesive AD.

In the invention, a time from a finishing point of the application of the adhesive AD to the transparent substrate COV until a starting point of the bonding is made 10 seconds or more and 120 seconds or less (desirably, 30 seconds or more and 60 seconds or less). This length of time suffices for a transfer time from a printing step to a bonding step. With this length of time, in the case of applying the adhesive AD of the heretofore described viscosity in the predetermined pattern, the adhesive AD spreading, it is possible to obtain a condition in which the maximum size of air bubbles is 0.5 mm or less. Moreover, by adopting this length of time, rather than causing the air bubbles to disappear completely, it is possible to obtain a condition in which some air bubbles remain. On carrying out the bonding in this condition, it is possible to carry out the bonding without drawing in large air bubbles, and moreover, vacuum air bubbles are diffused and made inconspicuous after the bonding. By this means, it is possible to suppress a remaining of air bubbles.

Also, in the invention, in the case of applying the adhesive AD, the screen printing is used. By this means, it is possible to apply the adhesive AD to the transparent substrate COV in the predetermined pattern in an extremely short time. For example, in a case of using a dispenser method, for example, for each two inch display panel PNL, it takes around 300 seconds to lift and move an applicator nozzle, resulting in an increasing length of time being required for the manufacturing.

Also, in the invention, as heretofore described, the viscosity of the adhesive AD is made more than 5000 mPa·s and 15000 mPa·s or less in the condition in which it has not yet been cured. In the case in which the viscosity is 5000 mPa·s or less, when the screen printing is carried out, the adhesive AD being likely to encroach upon an underside of a screen plate, it is necessary to clean the underside of the screen plate after 20 to 30 shots, resulting in the increasing length of time being required for the manufacturing. Conversely, in the case in which the viscosity is more than 15000 mPa·s, as a wet spread property of the adhesive AD becomes lower, it takes a longer time until obtaining the condition in which the maximum size of air bubbles is 0.5 mm or less, resulting in the increasing length of time being required for the manufacturing. Moreover, in the event that the viscosity is high, it is difficult to apply the adhesive AD in an ideal pattern by means of the screen printing and, as a result thereof, a problem occurs in that, it being impossible to control the size of air bubbles, air bubbles remain.

Also, within the heretofore described range of viscosity, in a case of adopting, for example, a pattern in which dots are disposed as the predetermined pattern of the adhesive AD, it is possible to make a minimum dot size immediately after the screen printing Ø 1.0 to 1.1 mm.

Although it is desirable that the adhesive AD contains an acrylic resin or an epoxy resin, it is also possible to use another material such as, for example, a silicon resin. Also, it is also acceptable that it is a mixed material such as epoxy acrylate.

Next, as shown in FIG. 2C, in a condition in which the bonding has been carried out, by carrying out an ultraviolet (UV) application, an ultraviolet curable adhesive AD is cured. As the ultraviolet curable adhesive AD is used, it is possible to cure it without worrying about an upper temperature limit of the display panel PNL, which becomes a problem in a case of using a thermal process. In this case, an examination of air bubbles is made before the UV application, and the UV application is carried out after the maximum size of the air bubbles have reached 0.1 mm or less. By reducing the maximum size of air bubbles after the adhesive AD has been cured to 0.1 mm or less, it is possible to reduce bright spots caused by the air bubbles to an invisible level.

In the condition in which the transparent substrate COV is bonded, it is possible to spread the adhesive AD to an extremity of the transparent substrate COV, as shown in FIG. 2C, in accordance with a viscosity or application quantity of the adhesive AD.

Herein, in the heretofore described bonding step and curing step, it is desirable that, in the condition in which the display panel PNL and the transparent substrate COV are bonded together, each of the display panel PNL and the transparent substrate COV is fixed into position with an unshown jig until the curing finishes.

It is desirable that an elastic modulus of the adhesive AD after being cured is 1,000 to 250,000 Pa at room temperature (25° C.). By this means, even in a case in which materials having different coefficients of thermal expansion are bonded together, it is possible to reduce stress by means of the adhesive AD. It is possible to measure the elastic modulus of the adhesive AD after being cured by means of a Thermo Mechanical Analysis (TMA).

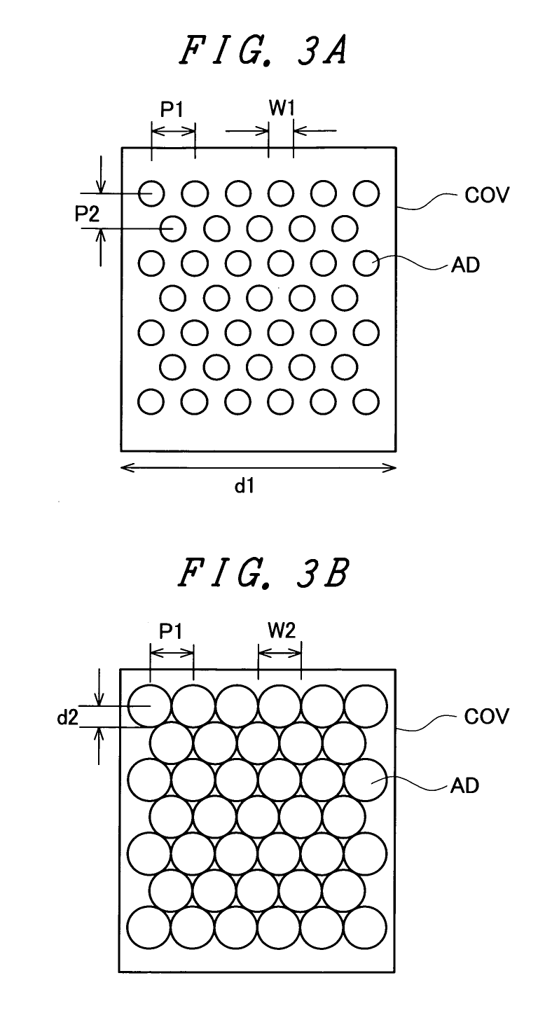

Next, a description will be given of an example of a pattern in which the adhesive AD is applied. FIGS. 3A and 3B are plan views illustrating one example of the pattern in which adhesive is applied. FIG. 3B is a plan view illustrating an aspect after the adhesive applied in the pattern of FIG. 3A has spread. FIG. 3A shows an example in which the adhesive AD is applied in a so-called stagger pattern in which dots of a width (a diameter) W1 are staggered at a pitch P1. That is, a disposition is such that dots in even number lines are displaced half the pitch in relation to dots in odd number lines. In this case, as the dots are not connected to one another, a portion in which there is no adhesive AD, that is, an air bubble, is of a very large size d1. On the dots spreading, a width (diameter) relationship is such that W2>W1 and, as they are connected to each other, as shown in FIG. 3B, the air bubble is divided into smaller ones of a size d2.

What is important here is that, rather than applying the adhesive AD uniformly and evenly, a pattern is deliberately adopted such that small air bubbles remain when the adhesive AD spreads, and furthermore that, as the air bubble is divided, the size d2 of each air bubble is small. In a case in which the adhesive AD is made uniformly even, or in a case in which an area to which no adhesive AD is applied (an air bubble) is large, although there is a possibility of drawing in large air bubbles, by deliberately carrying out the bonding with the divided small air bubbles remaining, it is possible to reduce the possibility of drawing in the large air bubbles at a time of the bonding. Consequently, it is possible to hold a size of vacuum air bubbles down to a degree such that the vacuum air bubbles can be diffused and made inconspicuous even after the bonding (in the embodiment, an arrangement is such that, at a stage of bonding the display panel PNL and the transparent substrate COV together, air bubbles remain, and a maximum value of a size of the air bubbles is 0.5 mm or less). Vacuum air bubbles remaining after the bonding are diffused, and made inconspicuous, by the time the curing of the adhesive AD is finished. As the fact that, by reducing the maximum size of air bubbles after the adhesive AD has been cured to 0.1 mm or less, it is possible to reduce the bright spots caused by the air bubbles to the invisible level, is as previously described, it is sufficient to wait until the air bubbles are diffused after the bonding, and the maximum size reach 0.1 mm or less, to cure the adhesive AD.

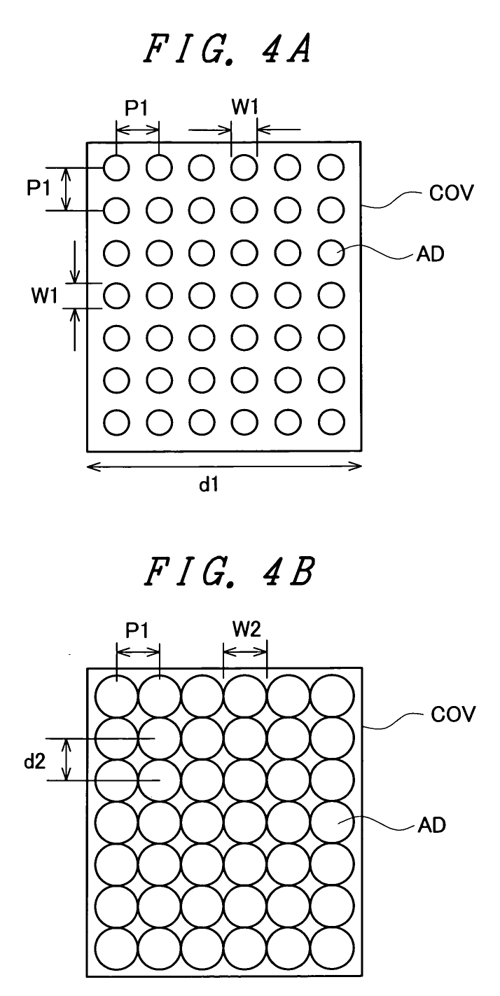

By staggering dots, as shown in FIG. 3A, an advantage is achieved in which, it being possible to dispose dots sparsely on the perimeter (in a vicinity of the extremity) of the transparent substrate COV, it is possible to make the adhesive AD unlikely to overflow the extremity of the transparent substrate COV, as will be apparent in comparison with FIGS. 4A and 4B to be described hereafter.

Although FIG. 3A shows a vertical pitch P2 taken to be P2>W1, it is also acceptable that P2 is further reduced to P2=W1 or P2<W1. P2<W1 is more preferable because adjacent dots become closer to each other.

Also, although it is also acceptable that the pitch P1 is taken to be P1>2W1, P1=2W1 or P1<2W1 is more preferable because adjacent dots become closer to each other.

FIGS. 4A and 4B are plan views illustrating another example of a pattern in which the adhesive is applied. FIG. 4A is a plan view illustrating one example of the pattern in which the adhesive is applied. FIG. 4B is a plan view illustrating an aspect after the adhesive applied in the pattern of FIG. 4 has spread. FIG. 4A shows an example in which the adhesive AD is shaped into dots disposed in a matrix form. Each dot of the adhesive AD is set to have a pitch P1 and a width (a diameter) W1. In this case, as the dots are not connected to one another, a portion in which there is no adhesive AD, that is, an air bubble, is of a very large size d1. After a while, the adhesive AD spreads, and a width (diameter) relationship is such that W2>W1, as shown in FIG. 4B. By this means, the air bubble is divided, and a size d2 of each air bubble becomes smaller than the size d1 of air bubbles immediately after the application.

As shown in FIGS. 3A, 3B, 4A and 4B, by shaping the adhesive AD into dots, and disposing them in the stagger or matrix form, it is possible to secure a uniform leveling property of the adhesive AD from the adhesive AD printing step to the bonding step. That is, a dot shaped adhesive AD spreads without losing its planar shape (that is, while maintaining its dot shape), and comes into contact with another adjacent dot shaped adhesive AD, dividing an air bubble. For this reason, an advantage is achieved in which it is possible to control a size of air bubbles in such a way that it is uniform and of a predetermined value.

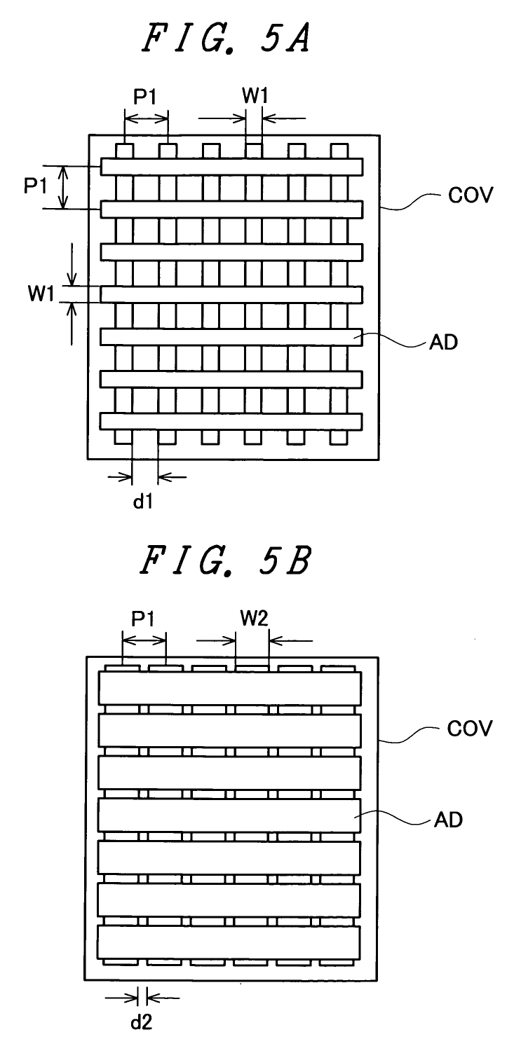

Furthermore, FIGS. 5A and 5B are plan views illustrating still another example of a pattern in which the adhesive is applied. FIG. 5A is a plan view illustrating one example of the pattern in which the adhesive is applied. FIG. 5B is a plan view illustrating an aspect after the adhesive applied in the pattern of FIG. 5A has spread. FIG. 5A shows an example in which the adhesive AD is applied in a grid pattern. In FIG. 5A, a size of air bubbles surrounded by the adhesive AD having a pitch P1 and a width W1 is d1. After a while, the adhesive spreads, and a width relationship is such that W2>W1, as shown in the figure. A size d2 of air bubbles becomes smaller than the size d1 of air bubbles immediately after the application.

The invention not being limited to the patterns described in FIGS. 3A, 3B, 4A, 4B, 5A and 5B, it is also acceptable to apply the adhesive AD in another pattern. Also, in the embodiment 1, a description has been given of the example in which the adhesive AD is applied to the transparent substrate COV side but, this not being limiting, it is also acceptable to apply the adhesive AD to the display panel PNL side.

### Embodiment 2

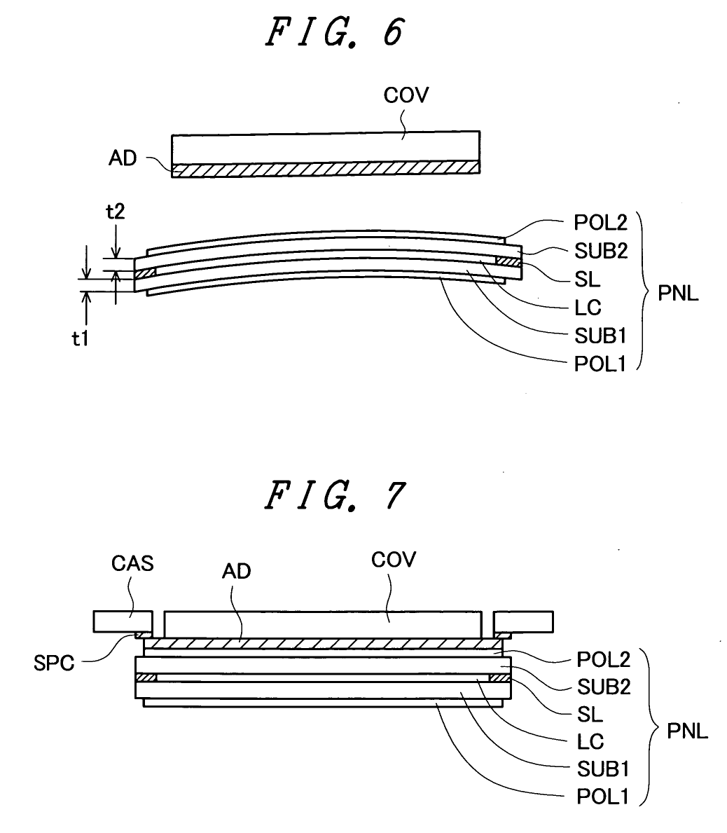

FIG. 6 is a side view illustrating one example of a method of manufacturing a display device of an embodiment 2 of the invention. When bonding the display panel PNL and the transparent substrate COV together, by their being bonded together while the display panel PNL is being bent in such a way as to be convex on a surface to be bonded, as shown in FIG. 6, it is possible to reduce a possibility of drawing in large air bubbles. In this case, it is desirable that a sum of a thickness t1 of the substrate SUB1 and a thickness t2 of the substrate SUB2 is 0.8 mm or less, more preferably, 0.6 mm or less. Although there is no particular restriction on a lower limit, it is desirable that the sum is 0.1 mm or more.

Although FIG. 6 shows an example in which the display panel PNL is being bent, this not being limiting, it is also acceptable that the display panel PNL and the transparent substrate COV are bonded together while only the transparent substrate COV, or both the display panel PNL and the transparent substrate COV, are being bent in such a way as to be convex on surfaces to be bonded.

### Embodiment 3

FIG. 7 is a sectional view illustrating one example of a display device of an embodiment 3 of the invention. A difference from FIG. 1 of the embodiment 1 is that the adhesive AD is extended to an extremity of the polarizing plate POL2. For example, by adjusting the viscosity, application pattern or application quantity of the adhesive AD, it is possible, at the time of the bonding, to spread the adhesive outside the extremity of the transparent substrate COV. Alternatively, by applying the adhesive AD to the display panel PNL side, too, it is possible to realize the invention.

### Embodiment 4

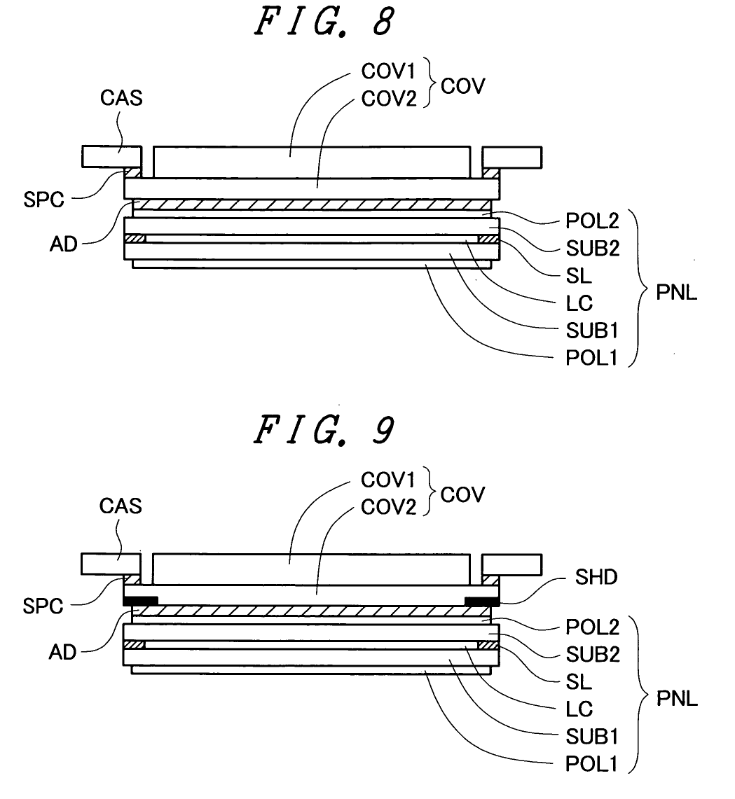

FIG. 8 is a sectional view illustrating one example of a display device of an embodiment 4 of the invention. A difference from the figure of the embodiment 3 is that the transparent substrate COV is configured of a transparent substrate COV1 and a transparent substrate COV2. The transparent substrate COV1 and the transparent substrate COV2 are attached with an unshown adhesive. A shape of the transparent substrate COV2 is larger than that of the transparent substrate COV1. The shape of the transparent substrate COV2 is larger than the opening of the casing CAS. Then, a spacer SPC is disposed between the transparent substrate COV2 and the casing CAS. The transparent substrate COV1 can be configured of, for example, glass, and the transparent substrate COV2 can be configured of, for example, an acrylic resin (PMMA). The transparent substrate COV configuration shown in the figure is only one example and, this not being limiting, it is also acceptable to use another configuration.

### Embodiment 5

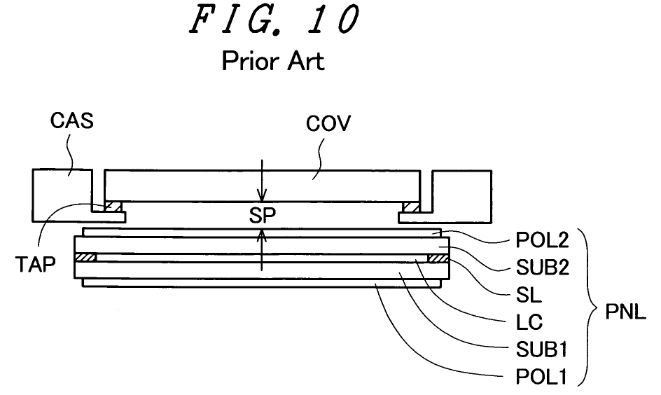

FIG. 9 is a sectional view illustrating one example of a display device of an embodiment 5 of the invention. A difference from the figure of the embodiment 4 is that a light shield SHD is included in one portion of the transparent substrate COV. For example, the light shield SHD is formed in a frame shape in such a way as to surround a perimeter of a display area of the display panel PNL. In this case, in an area overlapping the light shield SHD, as the adhesive AD cannot be sufficiently cured by means of the ultraviolet application, it is desirable that the adhesive AD is cured using both heat and ultraviolet light. However, in this case, in consideration of the upper temperature limit of the display panel PNL, a temperature of 50 to 80° C., more preferably, 55 to 70° C., is desirable. With this degree of temperature, it is possible to realize the invention by using a lamp of a high output (for example, 150 mW or more) as a lamp which delivers the UV application. As the adhesive AD does not have to be 100% cured, a temperature of a degree capable of carrying out a heat assist will suffice.

### Embodiment 6

The ultraviolet cure using the heat assist described in the embodiment 5 can also be applied to a display device in which no light shield SHD is formed on the transparent substrate COV.

### Embodiment 7

In the embodiments 1 to 6, it is also acceptable that a gap between the casing CAS and the transparent substrate COV is occluded by a second spacer configured of an unshown waterproof material such as silicon rubber, in place of the spacer SPC, or together with the spacer SPC. By this means, a waterproofing becomes possible. Also, it is also acceptable that the spacer SPC and the second spacer are integrally configured.

### Embodiment 8

The display panel PNL not being limited to the liquid crystal display panel, it is also possible to apply it to, for example, another type of display panel such as an inorganic EL display panel.

A description has heretofore been given of the invention, using the embodiments, but the configuration described so far in each embodiment being only one example, the invention can be appropriately modified without departing from the scope of the technological idea. Also, it is also acceptable that the configurations described in the individual embodiments are used in combination unless they conflict with each other.

What is claimed is:

1. A display device manufacturing method in which a transparent substrate is bonded to a display panel by means of an adhesive, the method comprising:
applying the adhesive to the display panel or the transparent substrate in a predetermined pattern;
bonding the display panel and the transparent substrate together by means of the adhesive after the applying step; and
curing the adhesive after the bonding, wherein
in the applying step, a viscosity of the adhesive being more than 5000 mPa·s and 15000 mPa·s or less, the application of the adhesive is carried out by means of a screen printing,
a time from a finishing point of the application of the adhesive in the applying step until a starting point of the bonding in the bonding step is 10 seconds or more and 120 seconds or less,
in the bonding step, in a condition in which the adhesive applied in the applying step is spreading, with air bubbles remaining, and a maximum size of the air bubbles is 0.5 mm or less, the display panel and the transparent substrate are bonded together by means of the adhesive under a reduced pressure atmosphere lower than the atmospheric pressure, and
in the curing step, after the maximum size of the air bubbles have reached 0.1 mm or less, ultraviolet light is applied, curing the adhesive.

2. The display device manufacturing method according to claim 1, wherein
the time from the adhesive application finishing point in the applying step until the bonding starting point in the bonding step is 30 seconds or more and 60 seconds or less.

3. The display device manufacturing method according to claim 1, wherein
the predetermined pattern of the adhesive is a pattern of a plurality of dots.

4. The display device manufacturing method according to claim 3, wherein
the pattern of the plurality of dots is a pattern of staggered dots.

5. The display device manufacturing method according to claim 1, wherein
the predetermined pattern of the adhesive is a grid pattern.

6. The display device manufacturing method according to claim 1, wherein
in the bonding step, a vacuum is 1 to 50 Torr.

7. The display device manufacturing method according to claim 1, wherein
in the bonding step, the display panel and the transparent substrate are bonded together by means of the adhesive while the display panel is being bent in such a way as to be convex on a surface to be bonded.

8. The display device manufacturing method according to claim 7, wherein
the display panel has a first substrate, and a second substrate disposed facing the first substrate, and
a sum of a thickness of the first substrate and a thickness of the second substrate is 0.6 mm or less.

9. The display device manufacturing method according to claim 1, wherein
in the curing step, the adhesive is cured using both heat and the ultraviolet light.

10. The display device manufacturing method according to claim 9, wherein
a light shield is included in one portion of the transparent substrate.

11. The display device manufacturing method according to claim 9, wherein
the heat is of 50 to 80° C.

12. The display device manufacturing method according to claim 1, wherein
the transparent substrate contains one or more of glass, an acrylic resin, and a polycarbonate resin.

13. The display device manufacturing method according to claim 1, wherein
the adhesive contains an acrylic resin or an epoxy resin.

14. The display device manufacturing method according to claim 1, wherein
in the bonding step and the curing step, in a condition in which the display panel and the transparent substrate are bonded together, each of the display panel and the transparent substrate is fixed into position with a jig.

15. The display device manufacturing method according to claim 1, wherein
an elastic modulus of the adhesive after being cured is 1,000 to 250,000 Pa at 25° C.

16. The display device manufacturing method according to claim 1, wherein
the display panel is a liquid crystal display panel.
